(19) United States
(12) Patent Application Publication
(10) Pub. No.: US 2026/0161492 A1
(43) Pub. Date: Jun. 11, 2026

(54) AUTO-GENERATING HUMAN-READABLE ALIASES FOR RPC CALL STACKS

(71) Applicant: Google LLC, Mountain View, CA (US)

(72) Inventor: Antonio Trapanese, Zurich (CH)

(73) Assignee: Google LLC, Mountain View, CA (US)

(21) Appl. No.: 18/977,890

(22) Filed: Dec. 11, 2024

(51) Int. Cl. G06F 9/54

(52) U.S. Cl. CPC G06F 9/547

(57) ABSTRACT

A method includes obtaining a call stack of a plurality of call stacks. Each call stack includes a respective sequence of remote procedure calls. The method includes determining one or more wordpiece tokens based on the respective sequence of remote procedure calls of the call stack. For each respective wordpiece token of the one or more wordpiece tokens, the method includes determining a corresponding frequency indicating a number of other call stacks of the plurality of call stacks associated with the respective wordpiece token. The method includes selecting a portion of the one or more wordpiece tokens from the one or more wordpiece tokens based on the corresponding frequency determined for each respective wordpiece token. The method includes assigning an alias corresponding to the portion of the one or more wordpiece tokens to the call stack.

### TECHNICAL FIELD

This disclosure relates to auto-generating human-readable aliases for RPC call stacks.

### BACKGROUND

Distributed computing systems often rely on Remote Procedure Calls (RPCs) to communicate and coordinate actions across different nodes. Analyzing the behavior of distributed computing systems is beneficial for understanding performance, diagnosing issues, and optimizing operations. One common approach for analyzing these systems involves examining RPC call stacks, which includes sequences of RPC calls that lead to specific actions on multiple nodes. However, this composition poses a challenge for visualization tools. Specifically, the sequences of RPC calls do not fit well in chart legends, labels, or other graphical elements, making it difficult to present the information in a clear and comprehensible manner. Even if the entire sequence of RPC calls could be accommodated, it is not readily apparent to a user the significance associated with each RPC call within the sequence.

### SUMMARY

One aspect of the disclosure provides a computer-implemented method that when executed on data processing hardware causes the data processing hardware to perform operations for generating aliases for call stacks. The operations include obtaining a call stack of a plurality of call stacks. Each call stack includes a respective sequence of remote procedure calls. The operations include determining one or more wordpiece tokens based on the respective sequence of remote procedure calls of the call stack. For each respective wordpiece token of the one or more wordpiece tokens, the operations include determining a corresponding frequency indicating a number of other call stacks of the plurality of call stacks associated with the respective wordpiece token. The operations include selecting a portion of the one or more wordpiece tokens based on the corresponding frequency determined for each respective wordpiece token. The operations include assigning an alias corresponding to the portion of the one or more wordpiece tokens to the call stack.

Implementations of the disclosure may include one or more of the following optional features. In some implementations, determining at least one wordpiece token of the one or more wordpiece tokens for each respective remote procedure call of the sequence of remote procedure calls. In these implementations, determining the at least one wordpiece token is based on a name of a corresponding endpoint associated with the respective remote procedure call. Each respective remote procedure call of the sequence of remote procedure calls may be associated with a corresponding endpoint node configured to perform a respective action with each corresponding endpoint node including a name semantically associated with the respective action. In some examples, determining the corresponding frequency includes determining a number of occurrences that the respective wordpiece token has been determined for other respective sequence of remote procedure calls of the other call stacks.

In some implementations, selecting the portion of the one or more wordpiece tokens includes selecting a predetermined number of respective wordpiece tokens associated with the lowest corresponding frequencies. Selecting the portion of the one or more wordpiece tokens may be based on a class of the call stack. The operations may further include determining a corresponding rank for each respective wordpiece token of the portion of the one or more wordpiece tokens, determining an order of the portion of the one or more wordpiece tokens based on the corresponding rank of each respective wordpiece token, and determining the alias based on the order. In some examples, the operations further include determining usage data of the call stack and displaying a graphical representation of the usage data in association with the alias assigned to the call stack. The operations may further include appending a fingerprint or a checksum value to the alias assigned to the call stack.

Another aspect of the disclosure provides a system that includes data processing hardware and memory hardware storing instructions that when executed on the data processing hardware causes the data processing hardware to perform operations. The operations include obtaining a call stack of a plurality of call stacks. Each call stack includes a respective sequence of remote procedure calls. The operations include determining one or more wordpiece tokens based on the respective sequence of remote procedure calls of the call stack. For each respective wordpiece token of the one or more wordpiece tokens, the operations include determining a corresponding frequency indicating a number of other call stacks of the plurality of call stacks associated with the respective wordpiece token. The operations include selecting a portion of the one or more wordpiece tokens based on the corresponding frequency determined for each respective wordpiece token. The operations include assigning an alias corresponding to the portion of the one or more wordpiece tokens to the call stack.

Implementations of the disclosure may include one or more of the following optional features. In some implementations, determining at least one wordpiece token of the one or more wordpiece tokens for each respective remote procedure call of the sequence of remote procedure calls. In these implementations, determining the at least one wordpiece token is based on a name of a corresponding endpoint associated with the respective remote procedure call. Each respective remote procedure call of the sequence of remote procedure calls may be associated with a corresponding endpoint node configured to perform a respective action with each corresponding endpoint node including a name semantically associated with the respective action. In some examples, determining the corresponding frequency includes determining a number of occurrences that the respective wordpiece token has been determined for other respective sequence of remote procedure calls of the other call stacks.

In some implementations, selecting the portion of the one or more wordpiece tokens includes selecting a predetermined number of respective wordpiece tokens associated with the lowest corresponding frequencies. Selecting the portion of the one or more wordpiece tokens may be based on a class of the call stack. The operations may further include determining a corresponding rank for each respective wordpiece token of the portion of the one or more wordpiece tokens, determining an order of the portion of the one or more wordpiece tokens based on the corresponding rank of each respective wordpiece token, and determining the alias based on the order. In some examples, the operations further include determining usage data of the call stack and displaying a graphical representation of the usage data in association with the alias assigned to the call stack. The operations may further include appending a fingerprint or a checksum value to the alias assigned to the call stack.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system executing an alias generator.

FIG. 2 is an illustrative view of an example call stack with an assigned alias.

FIG. 3 is a schematic view of an example assignor, FIG. 4 illustrates an example graphical representation of usage data of a call stack.

FIG. 5 is a flowchart of an example arrangement of operations for a computer-implemented method of generating aliases for call stacks.

FIG. 6 is a schematic view of an example computing device that may be used to implement the systems and methods described herein.

Like reference symbols in the various drawings indicate like elements.

### DETAILED DESCRIPTION

Distributed computing systems enable the execution of complex tasks across multiple nodes. Distributed computing systems often rely on Remote Procedure Calls (RPCs) to facilitate communication and coordination among the various nodes. RPCs allow applications or programs to cause a procedure to execute on another node, typically on another physical machine. Thus, RPCs abstract the complexity of network communication and provide a straightforward interface for invoking remote services.

Analyzing the behavior of distributed computing systems allows for understanding system performance, diagnosing issues, and optimizing operations. One method for such analysis involves examining RPC call stacks. An RPC call stack is a sequence of RPC calls that trace the path of execution leading to specific actions on multiple nodes within the system. These call stacks provide valuable insights into the interactions and dependencies between different components of the distributed computing system. However, the inherent complexity of distributed computing systems poses significant challenges for analysis and visualization. The data generated by these distributed computing systems is vast and often takes the form of intricate data structures, such as trees or more complex types of graphs. While simplifying this data into RPC call stacks makes the data more manageable, the data still remains difficult to comprehend and visualize effectively.

In particular, a typical RPC call stack is composed of several strings, each representing a node or RPC endpoint. This composition does not lend itself well to traditional visualization tools, such as chart legends or labels. The length and complexity of these strings make it difficult to fit them into graphical elements without overwhelming the viewer or even exceeding the amount of space available on a screen of a user device. Moreover, even if the entire sequence of RPC calls could be displayed, it is not immediately clear which nodes are more significant in terms of their contribution to the overall computation. Many nodes may represent boilerplate or infrastructure services that do not add much to the semantic understanding of the computation, further complicating the analysis.

To that end, implementations herein are directed towards an alias generator that obtains a call stack of a plurality of call stacks. Each call stack includes a respective sequence of RPCs. The alias generator determines one or more wordpiece tokens based on the respective sequence of RPCs of the call stack. For each respective wordpiece token of the one or more wordpiece tokens, the alias generator determines a corresponding frequency indicating a number of other call stacks of the plurality of call stacks associated with the respective wordpiece token. The alias generator selects a portion of the one or more wordpiece tokens from the one or more wordpiece tokens based on the corresponding frequency determined for each respective wordpiece token.

The alias generator assigns an alias corresponding to the portion of the one or more wordpiece tokens to the call stack.

Advantageously, the alias generator determines the one or more wordpiece tokens based on names of corresponding endpoints associated with the sequence of remote procedure calls. Each corresponding endpoint is associated with a name that is semantically associated with a respective action the corresponding endpoint is configured to perform. Thus, by selecting a portion of the one or more wordpiece tokens of the call stack, the alias generator assigns an alias to the call stack that succinctly describes actions performed by the call stack. As a result, visualization tools may display information regarding the call stack and label the call stack with the alias such that the entire alias may be displayed by the visualization tool and describe significant nodes of the call stack. Moreover, since the alias corresponds to the portion of the one or more wordpiece tokens (rather than all the one or more wordpiece tokens), storing and processing the alias reduces the amount of computational resources consumed (e.g., data processing hardware and memory hardware).

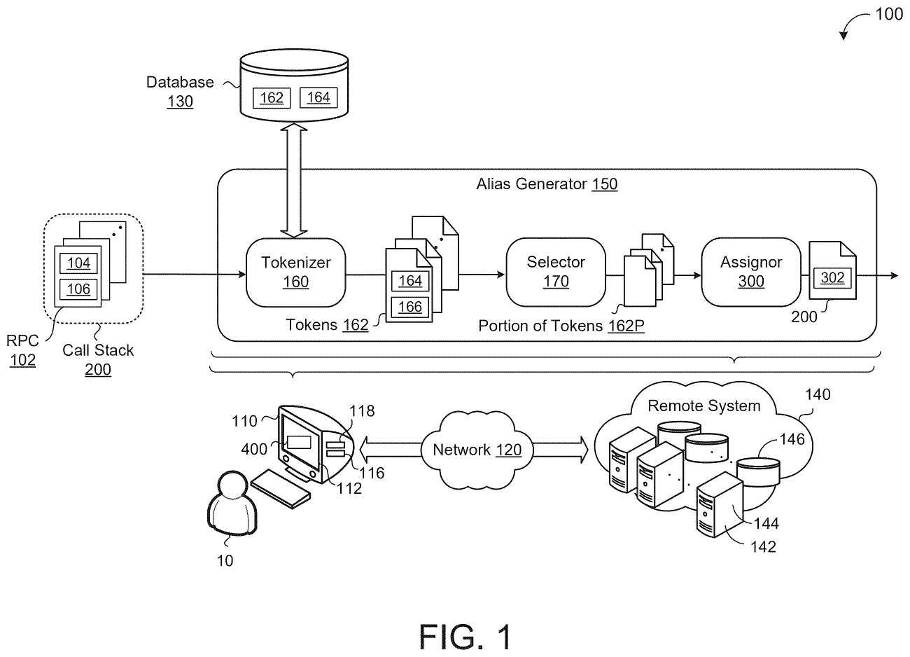

Referring to FIG. 1, in some implementations, a system 100 includes a remote system 140 in communication with one or more user device 110 each associated with a respective user 10 via a network 120, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware).

The remote system 140 is configured to communicate with the user device 110 via the network 120. The user device 110 may correspond to any computing device, such as a desktop workstation, a laptop workstation, or a mobile device (i.e., a smart phone). Each user device 110 includes computing resources 116 (e.g., data processing hardware) and/or storage resources 118 (e.g., memory hardware).

The remote system 140 and/or the user device 110 may execute an alias generator 150. For instance, some components of the alias generator 150 may execute on the data processing hardware 116 of the user device 110 while other components of the alias generator 150 execute on the data processing hardware 144 of the remote system 140. In some examples, all components of the alias generator 150 execute on the data processing hardware 116 of the user device 110 or the data processing hardware 144 of the remote system 140. The alias generator 150 includes a tokenizer 160, a selector 170, and an assignor 300.

The tokenizer 160 obtains a call stack 200 of a plurality of call stacks 200. In some examples, the call stacks 200 are remote procedure call (RPC) stacks. Thus, each call stack 200 may include a respective sequence of RPCs 102. An RPC 102 is a protocol that one program or application uses to request a service from another program or application located on another computer in a computing system. RPCs 102 allows a program to execute a procedure (e.g., subroutine) on the remote system 140 as if it were a local procedure call, abstracting the complexity of the network communication. In other examples, the call stacks 200 are local procedure call stacks (e.g., local stack trace) each including a respective sequence of local procedure calls. The local procedure call is a protocol that one program or application uses to request a service from another program or application located within the same computer in the computing system. Unlike RPCs 102, local procedure calls do not involve network communication, as the service request and execution occur within the same machine. The primary difference between RPCs 102 and local procedure calls lies in their scope of operation. RPCs 102 facilitate communication and service requests between programs on different computers, making them useful for distributed computing environments. In contrast, local procedure calls operate within the confines of a single computer, making them suitable for tasks that do not require inter-computer communication.

RPCs 102 are particularly useful in distributed computing systems where different components of an application may reside on different nodes. For example, a web application with a front-end interface hosted on one node of the remote system 140, and a back-end database is hosted on another node of the remote system 140. When the front-end needs to retrieve data from the database, the front-end may use an RPC 102 to request the data from the back-end server. The front-end sends an RPC 102 to the node of the back-end database, which processes the RPC 102, retrieves the necessary data, and sends the data to the node of the front-end interface.

An RPC call stack 200 includes a sequence of RPCs 102 made during the execution of a program. Each entry in the call stack 200 represents an RPC 102, including information such as a name of the RPC 102, parameters passed to the RPC 102, and the return address. For instance, if a client application makes a series of RPCs 102 to the remote system 140, the call stack 200 will record each of these RPCs 102 in the order they were received. The call stacks 200 help in debugging and understanding the flow of the program, as developers can trace back through the call stack 200 to see the sequence of RPCs 102 that led to a particular state or error.

Each respective RPC 102 of the sequence of RPCs 102 is associated with a corresponding endpoint node 104 configured to perform a respective action 106. Moreover, each corresponding endpoint node 104 includes a name semantically associated with the respective action 106. For instance, a corresponding endpoint node 104 with the name “DirectionsAssist” may be configured to perform one or more direction assistance actions. Here, notably, the name of the corresponding endpoint node 104 is directly related to the type of actions 106 the corresponding endpoint 104 is configured to perform. On the other hand, each respective local procedure call of the sequence of local procedure calls is associated with a corresponding local function call that is configured to perform a respective action 106. Each function call may include name that is semantically associated with the respective action 106.

The tokenizer 160 is configured to determine one or more wordpiece tokens 162 based on the respective sequence of remote procedure calls 102. In particular, the tokenizer may determine the one or more wordpiece tokens 162 based on the name of the corresponding endpoints 104 of each respective RPC 102 of the call stack. Moreover, the tokenizer 160 may determine the one or more wordpiece tokens 162 based on the name of the local function call of each respective local procedure call of the call stack 200 in addition to, or in lieu of, the RPCs 102. In short, the tokenizer 160 processes the names of the endpoint nodes 104 (or local function calls) to generate wordpiece tokens 162. Each wordpiece token 162 may correspond to a word, bigram, or N-gram of one of the names of the corresponding endpoints 104. In some implementations, for each respective RPC 102 of the sequence of RPCs 102, the tokenizer 60 determines at least one wordpiece token 162 of the one or more wordpiece tokens 1042 determines for the sequence of RPCs 102.

For example, for a sequence of RPCs 102 that has a first RPC 102 associated with an endpoint 104 with the name “getUserData” and a second RPC 102 associated with an endpoint 104 with the name “updateUserProfile,” the tokenizer 160 processes these names to generate the one or more wordpiece tokens 162. In this example, for “getUserData” the tokenizer 160 determines the wordpiece tokens 162 of “get,” “User,” and “Data,” and the tokenizer 160 determines the wordpiece tokens 162 of “update,” “User,” and “Profile” for “updateUserProfile.” Here, each wordpiece token 162 corresponds to a word. Alternatively, for “getUserData” the tokenizer 160 may determine the wordpiece tokens 162 of “getUser” and “Data” and the tokenizer 160 determines the wordpiece tokens 162 of “update” “UserProfile.” Here, each wordpiece token corresponds to an N-gram.

Moreover, for each respective wordpiece token 162 of the one or more wordpiece tokens 162 in the call stack 200, the tokenizer 160 determines a corresponding frequency 164. Each corresponding frequency 164 indicates a number of other call stacks 200 of the plurality of call stacks 200 associated with the respective wordpiece token 162. Simply put, for each respective wordpiece token 162, the tokenizer 160 determines how frequently the respective wordpiece token 162 appears across the plurality of call stacks 200. Put another way, the tokenizer 160 determines a number of occurrences that the tokenizer 160 has determined for other respective RPCs 102 of other call stacks 200. By determining the corresponding frequency 164 with each wordpiece token, the alias generator 150 may identify common and unique RPCs 102 across the plurality of call stacks 200.

In some examples, the tokenizer 160 communicates with a database 130 to determine the corresponding frequency 164 for each respective wordpiece token 162. The database 130 may store all of the wordpiece tokens 162 determined by the tokenizer 160 for each RPC 102 of the plurality of call stacks 200. The database 130 serves as a repository for the wordpiece tokens 162 and the corresponding frequency 164, enabling efficient retrieval and analysis of token usage patterns across different RPCs 102 of the plurality of call stacks 200. For example, the tokenizer 160 may determine that the wordpiece token 162 of “User” has been determined for ten (10) other RPCs 102 of the plurality of call stacks 200 by communicating with the database 130. Thus, in this example, the tokenizer 160 determines the frequency 164 of ten (1) for the wordpiece token 162 of “User.”

Each RPC 102 may be associated with a particular class 166 characterizing the RPC 102. For instance, the class 166 may indicate that a respective RPC 102 is a user-facing RPC 102, a test environment RPC 102, a development environment RPC 102, or a prober RPC 102. The user-facing RPC 102 may interact directly with users 10, providing them with necessary functionalities and responses. The test environment RPC 102, on the other hand, may be utilized within a controlled testing environment to ensure the reliability and performance of the system before deployment. Similarly, the development environment RPC 102 may be used by developers during the creation and refinement of the system, allowing for iterative testing and debugging. The prober RPC 102 may serve a specialized role in probing and monitoring the system for performance metrics, anomalies, or other diagnostic purposes. To that end, the tokenizer 160 may be configured to determine the class 166 for each wordpiece token 162 of the one or more wordpiece tokens 162 based on the respective RPC 102 associated with the wordpiece token 162.

The selector 170 is configured to select a portion of the one or more wordpiece tokens 162, 162P from the one or more wordpiece tokens 162 based on the corresponding frequency 164 determined for each respective wordpiece token 162. That is, from the one or more wordpiece tokens 162 determined for the sequence of RPCs 102 of the call stack 200, the selector 170 selects the portion of the one or more wordpiece tokens 162P. In some examples, the selector 170 selects a predetermined number (e.g., three) of respective wordpiece tokens 162 associated with the lowest corresponding frequencies 164. For example, a sequence of RPCs 102 that generates a first wordpiece token 162 with a corresponding frequency 164 of ‘5,’ a second wordpiece token 162 with a corresponding frequency 164 of ‘3,’ a third wordpiece token 162 with a corresponding frequency 164 of ‘8,’ a fourth wordpiece token 162 with a corresponding frequency 164 of ‘2,’ and a fifth wordpiece token 162 with a corresponding frequency 164 of ‘7.’ In this example, where the predetermined number is 3, the selector 170 selects the first, second, and fourth wordpiece tokens 162 since these wordpiece tokens 162 have the lowest corresponding frequencies 164 of ‘5,’ ‘3,’ and ‘2,’ respectively.

In some implementations, the selector 170 selects the predetermined number of respective wordpiece tokens 162 associated with the lowest corresponding frequencies 164 and have a corresponding frequency greater than or equal to two. That is, while the selector selects wordpiece tokens 162 with the lowest corresponding frequencies 164, the selector 170 may not select wordpiece tokens 162 with a frequency equal to one or less since these wordpiece tokens 162 do not adequately inform. The rationale behind this exclusion is that wordpiece tokens 162 with a frequency 164 of one or less do not provide sufficient informative value. Such wordpiece tokens 162 are often unique to a single call stack 200 and do not contribute to a broader understanding or analysis. By excluding these low-frequency wordpiece tokens 162, the selector 170 ensures that the selected wordpiece tokens 162 are more representative and informative, thereby enhancing the overall utility and accuracy of the analysis.

In some configurations, the selector 170 privileges certain classes 166 of wordpiece tokens 162 during selection. For example, each call stack 200 may be tagged differently based on the context of the call stack 200, such as user-facing environments versus test or development environments, or probers. Thus, the class 166 of the wordpiece tokens 162 allows the selector 170 to prioritize and include wordpiece tokens 162 from user-facing call stacks over those from test or development environments. Thus, the selector 170 may ensure that the most relevant and informative wordpiece tokens 162 are included in the portion of the one or more wordpiece tokens 162P.

To that end, the selector 170 may select the portion of the one or more wordpiece tokens 162P further based on the class 166 associated with each wordpiece token 162. The selector 170 may use the classes 166 for the selection of wordpiece tokens 162, ensuring that the most critical and contextually appropriate wordpiece tokens 162 are included in the portion of the one or more wordpiece tokens 162P. In some examples, the selector 170 selects the portion of the one or more wordpiece tokens 162 by selecting a predetermined number of wordpiece tokens 162 from each class 166. For instance, the selector 170 may be configured to select one wordpiece token 162 from a first class 166 and two wordpiece tokens 162 from a second class 166.

The assignor 300 receives the portion of the one or more wordpiece tokens 162P and assigns an alias 302 to the call stack 200. The alias 302 may correspond to the portion of the one or more wordpiece tokens 162P. For instance, the alias 302 may concatenate the wordpiece tokens 162 from the portion of the one or more wordpiece tokens 162P such that the concatenation serves as the alias 302. Notably, the alias 302 is assigned to the call stack 200 such that the alias 302 represents the entire sequence of RPCs 102 in the call stack 200.

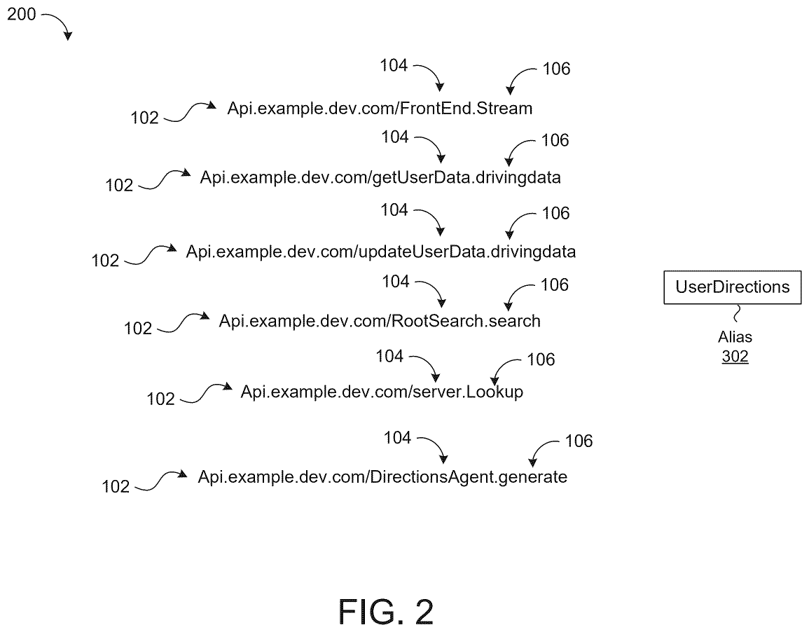

FIG. 2 illustrates an example call stack 200 with an assigned alias 302. The call stack 200 includes six RPCs 102 each represented by a corresponding URI. Moreover, each RPCs 102 includes a corresponding endpoint 104 and is configured to perform a respective type of action 106. For instance, one of the RPCs 102 includes the corresponding endpoint 104 of “FrontEnd” that is configured to perform the action 106 of “Stream.” Moreover, another RPCs 102 includes the corresponding endpoint 104 of “DirectionsAgent” that is configured to perform the action 106 of “generate.” The alias generator 150 (FIG. 1) determine one or more wordpiece tokens 162 for the sequence of RPCs 102 in the call stack 200 and selects the wordpiece tokens 162 “User” and “Directions” as the portion of the one or more wordpiece tokens 162. Thus, the alias generator 150 determines the alias 302 of “UserDirections” and assigns the alias 302 to the call stack 200. As such, the alias 302 may be used in association with the call stack 200 instead of the entire sequence of RPCs 102. Yet, the alias 302 still represents the actions of the call stack 200 indicating that the call stack 200 is associated with “Users” and “Directions.”

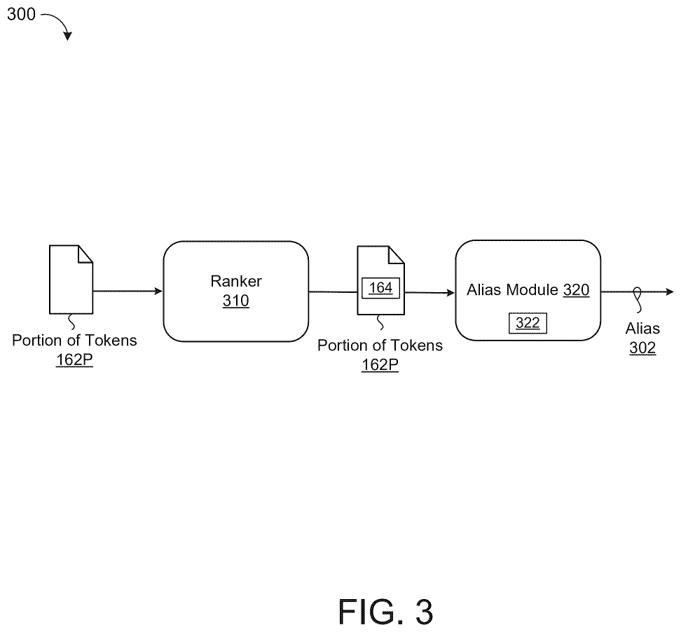

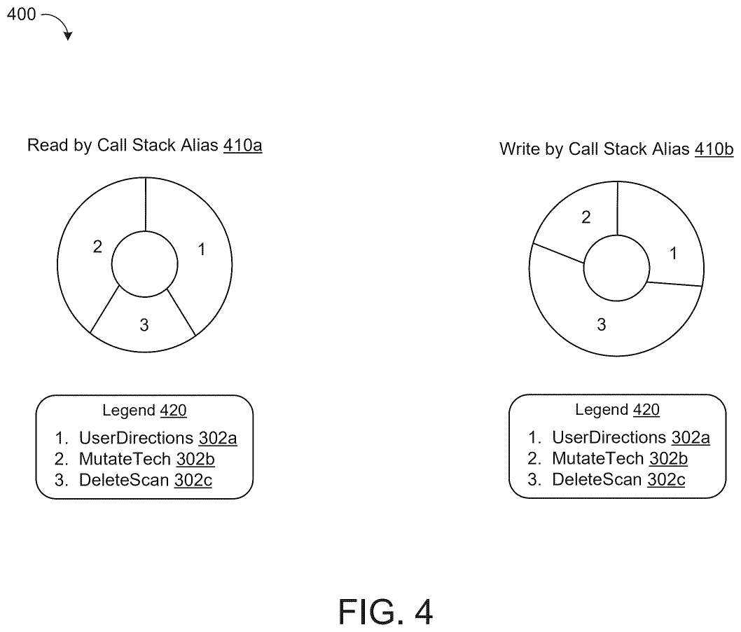

Referring now to FIG. 3, in some implementations, the assignor 300 includes a ranker 310 and an alias module 320. The ranker 310 is configured to determine a corresponding rank 312 for each respective wordpiece token 162 of the portion of the one or more wordpiece tokens 162P. The ranker 310 may determine each corresponding rank 312 based on the corresponding frequency 164 of the respective wordpiece token 162 whereby the ranker 310 determines a higher rank 312 for respective wordpiece tokens 162 with lower frequencies 164. For example, if a first wordpiece token 162 has a frequency 164 of ten and a second wordpiece token 162 has a frequency of two, the ranker 310 will assign a higher rank to the second wordpiece token 162 than the first wordpiece token 162.

The alias module 320 is configured to determine an order 322 of the portion of the one or more wordpiece tokens 162P based on the corresponding rank 312 of each respective wordpiece token 162. Wordpiece tokens 162 with higher ranks 312 occur carlier in the order 322 than wordpiece tokens 162 with lower ranks 312. Thereafter, the alias module 320 determines the alias 302 based on the order 322. The alias module 320 may concatenate each wordpiece token 162 in the portion of the one or more wordpiece tokens 162 according to the order 322. For example, if the order of the portion of the one or more wordpiece tokens 162P corresponds to “User” first and then “Directions,” the alias module 320 determines the alias 302 of “UserDirections.”

In some implementations, the alias module 320 determines a fingerprint value or a checksum value for the alias 302 and appends the fingerprint value or the checksum value to the alias 302. The fingerprint value or checksum value serves as a unique identifier that enhances the distinctiveness of each alias 302, thereby reducing the likelihood of collisions or duplications of aliases 302. Once the fingerprint or checksum value is determined, it is concatenated with the alias 302 to form an extended alias 302. The extended alias 302 retains the characteristics of the original alias 302 while incorporating the additional fingerprint or checksum value, thereby achieving a balance between generalization and uniqueness. Moreover, the alias module 320 may include configurable parameters that allow users 10 to adjust the level of generalization and uniqueness according to specific application requirements. For example, in scenarios where a higher degree of uniqueness is critical, the parameters may be configured to use more complex and secure fingerprint algorithms. Conversely, in applications where generalization is more important, simpler checksum methods may be preferred.

Referring back to FIG. 1, in some implementations the user device 110 and/or the remote system 140 determine usage data 410 (FIG. 4) of the call stack 200. The usage data 410 may encompass various types of operations performed by the call stack 200. For instance, the usage data 410 may include read operations executed by the call stack 200, which involve accessing and retrieving data. The read operations recorded in the usage data 410 can provide insights into the frequency and nature of data access patterns, which can be critical for optimizing performance and resource allocation of the remote system 140. Additionally, the usage data 410 may also include call operations initiated by the call stack 200. The call operations captured in the usage data 410 can reveal the sequence and hierarchy of function calls, which is essential for debugging, profiling, and enhancing the overall efficiency of the remote system 140. The remote system 140 may send the usage data 410 to the user device 110 which is configured to display a graphical representation 400 of the usage data 410 in association with the alias 302 assigned to the call stack 200. The user device 110 may display the graphical representation 400 on a screen 112 of the user device 110.

FIG. 4 illustrates an example graphical representation 400 of the usage data 410 displayed in association with aliases 302 assigned to call stacks 200. In the example shown, the graphical representation 400 displays first usage data 410, 410a representing read information by call stack 200 alias 302. In particular, the graphical representation 400 depicts a pie chart displaying the portion of read calls performed by each call stack 200. Notably, a legend 420 displays aliases 302, 302a-c for three different call stacks 200. Thus, rather than displaying an arbitrary name with the call stack 200 (e.g., first call stack 200, second call stack 200, etc.) or displaying the entire sequence of RPCs 102 (as shown in FIG. 2), the legend 420 associates the usage data 410 with the alias 302 of each call stack 200. Similarly, the graphical representation 400 displays second usage data 410, 410b representing write information by call stack 200 alias 302. In particular, the graphical representation 400 depicts a pie chart displaying the portion of write calls performed by each call stack 200.

Advantageously, by displaying the usage data 410 of call stacks 200 and tagging the usage data 410 with the alias 302 of the call stack 200 (rather than an arbitrary name or the entire sequence of RPCs 102 more usage data 410 may be displayed on the screen 112 of the user device 110 which enhances the visualization of the usage data 410. Thus, by determining the aliases 302, the context generator 150 optimizes the display of usage data 410 on the screen 112, allowing for a more efficient and user-friendly interface. By condensing the call stack 200 into a simplified alias 302, the context generator 150 reduces the complexity and volume of data that needs to be rendered on the screen 112. This not only enhances the readability of the information presented but also minimizes the computational resources required for data processing and visualization. Displaying usage information 410 with aliases 302 is particularly advantageous in environments where the area of the screen 112 is limited, such as on mobile devices or dashboards with multiple data streams. Consequently, more usage data 410 may be displayed concurrently, providing users 10 with a comprehensive overview of system performance and behavior without overwhelming them with excessive details.

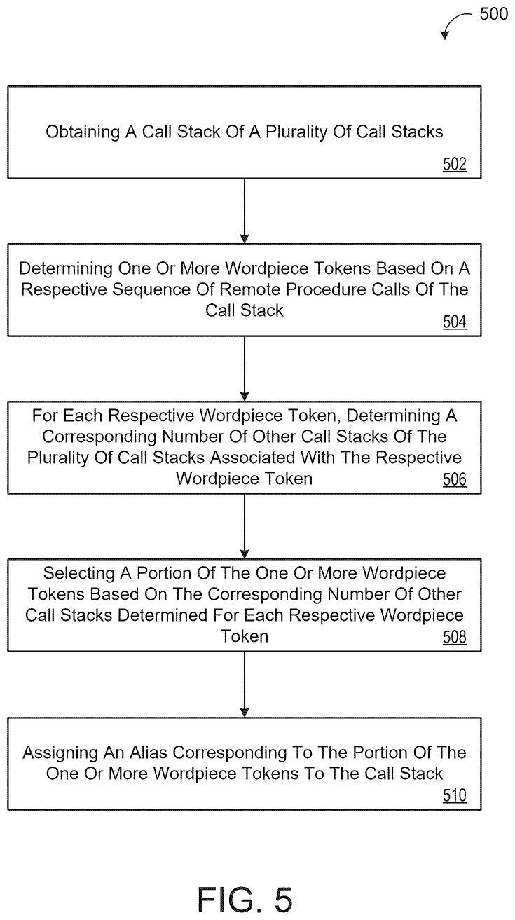

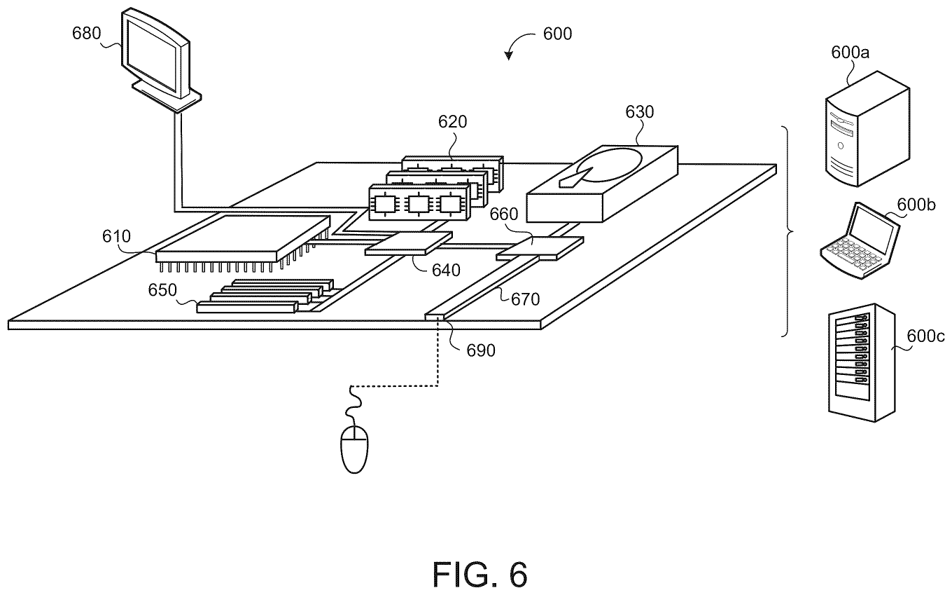

FIG. 5 illustrates a flowchart of an example arrangement of operations for a computer-implemented method 500 of generating aliases for call stacks. The method 500 may execute on data processing hardware 610 (FIG. 6) using instructions stored on memory hardware 620 (FIG. 6). The data processing hardware 610 (e.g., the data processing hardware 118 of the user device 110 and/or the data processing hardware 144 of the remote system 140) and the memory hardware 620 (e.g., the memory hardware 118 of the user device 110 and/or the memory hardware 146 of the remote system 140) may reside on the user device 110 and/or the remote system 140 of FIG. 1 each corresponding to a computing device 600 (FIG. 6).

At operation 502, the method 500 includes obtaining a call stack 200 of a plurality of call stacks 200. Each call stack 200 includes a respective sequence of remote procedure calls 102, In some examples, each call stack 200 includes a respective sequence of local procedure calls in addition to, or in lieu of the, sequence of remote procedure calls 102. At operation 504, the method 500 includes determining one or more wordpiece tokens 162 based on the respective sequence of remote procedure calls 102 of the call stack 200. In some examples, the method 500 determines the one or more wordpiece tokens 162 based on the respective sequence of local procedure calls of the call stack 200. At operation 506, the method 500 includes determining a corresponding frequency 164 indicating a number of other call stacks 200 of the plurality of call stacks 200 associated with the respective wordpiece token 162 for each respective wordpiece token 162 of the one or more wordpiece tokens 162. At operation 508, the method 500 includes selecting a portion of the one or more wordpiece tokens 162P from the one or more wordpiece tokens 162 based on the corresponding frequency 164. At operation 510, the method 500 includes assigning an alias 302 corresponding to the portion of the one or more wordpiece tokens 162P to the call stack 200.

Advantageously, the alias generator 150 enhances the analysis and visualization of call stacks 200 in distributed computing systems. Examining call stacks 200 is often hindered by the complexity and length of the RPC sequences 102 and local procedure call sequences, which do not fit well into graphical elements such as chart legends or labels. The alias generator 150 addresses these challenges by generating human-readable aliases 302 for call stacks 200, thereby simplifying the representation of complex sequences. By determining wordpiece tokens 162 based on the names of corresponding endpoints 104 and selecting wordpiece tokens 162 with the lowest frequencies 164, the alias generator 150 assigns concise and meaningful aliases 302 to call stacks 200. This not only improves the clarity and comprehensibility of the data but also reduces the computational resources required for storage and processing the data. Consequently, the alias generator 150 facilitates more efficient debugging, performance analysis, and system optimization.

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
obtaining a call stack of a plurality of call stacks, each call stack comprising a respective sequence of remote procedure calls;
based on the respective sequence of remote procedure calls of the call stack, determining one or more wordpiece tokens;
for each respective wordpiece token of the one or more wordpiece tokens, determining a corresponding frequency indicating a number of other call stacks of the plurality of call stacks associated with the respective wordpiece token;
based on the corresponding frequency determined for each respective wordpiece token, selecting, from the one or more wordpiece tokens, a portion of the one or more wordpiece tokens; and
assigning, to the call stack, an alias corresponding to the portion of the one or more wordpiece tokens.

2. The method of claim 1, wherein the operations further comprise, for each respective remote procedure call of the sequence of remote procedure calls, determining at least one wordpiece token of the one or more wordpiece tokens.

3. The method of claim 2, wherein determining the at least one wordpiece token is based on a name of a corresponding endpoint associated with the respective remote procedure call.

4. The method of claim 1, wherein each respective remote procedure call of each of the respective sequence of remote procedure calls is associated with a corresponding endpoint node configured to perform a respective action, each corresponding endpoint node comprising a name semantically associated with the respective action.

5. The method of claim 1, wherein determining the corresponding frequency comprises determining a number of occurrences that the respective wordpiece token has been determined for other respective sequence of remote procedure calls of the other call stacks.

6. The method of claim 1, wherein selecting the portion of the one or more wordpiece tokens comprises selecting a predetermined number of respective wordpiece tokens associated with the lowest corresponding frequencies.

7. The method of claim 1, wherein selecting the portion of the one or more wordpiece tokens is based on a class of the call stack.

8. The method of claim 1, wherein the operations further comprise:
for each respective wordpiece token of the portion of the one or more wordpiece tokens, determining a corresponding rank;
determining an order of the portion of the one or more wordpiece tokens based on the corresponding rank of each respective wordpiece token; and
determining the alias based on the order.

9. The method of claim 1, wherein the operations further comprise:
determining usage data of the call stack, and
displaying a graphical representation of the usage data in association with the alias assigned to the call stack.

10. The method of claim 1, wherein the operations further comprise appending a fingerprint or a checksum value to the alias assigned to the call stack.

11. A system comprising:
data processing hardware; and
memory hardware in communication with the data processing hardware, the memory hardware storing instructions that when executed on the data processing hardware cause the data processing hardware to perform operations comprising:
obtaining a call stack of a plurality of call stacks, each call stack comprising a respective sequence of remote procedure calls;
based on the respective sequence of remote procedure calls of the call stack, determining one or more wordpiece tokens;
for each respective wordpiece token of the one or more wordpiece tokens, determining a corresponding frequency indicating a number of other call stacks of the plurality of call stacks associated with the respective wordpiece token;
based on the corresponding frequency determined for each respective wordpiece token, selecting, from the one or more wordpiece tokens, a portion of the one or more wordpiece tokens; and
assigning, to the call stack, an alias corresponding to the portion of the one or more wordpiece tokens.

12. The system of claim 11, wherein the operations further comprise, for each respective remote procedure call of the sequence of remote procedure calls, determining at least one wordpiece token of the one or more wordpiece tokens.

13. The system of claim 12, wherein determining the at least one wordpiece token is based on a name of a corresponding endpoint associated with the respective remote procedure call.

14. The system of claim 11, wherein each respective remote procedure call of each of the respective sequence of remote procedure calls is associated with a corresponding endpoint node configured to perform a respective action, each corresponding endpoint node comprising a name semantically associated with the respective action.

15. The system of claim 11, wherein determining the corresponding frequency comprises determining a number of occurrences that the respective wordpiece token has been determined for other respective sequence of remote procedure calls of the other call stacks.

16. The system of claim 11, wherein selecting the portion of the one or more wordpiece tokens comprises selecting a predetermined number of respective wordpiece tokens associated with the lowest corresponding frequencies.

17. The system of claim 11, wherein selecting the portion of the one or more wordpiece tokens is based on a class of the call stack.

18. The system of claim 11, wherein the operations further comprise:
for each respective wordpiece token of the portion of the one or more wordpiece tokens, determining a corresponding rank;
determining an order of the portion of the one or more wordpiece tokens based on the corresponding rank of each respective wordpiece token; and
determining the alias based on the order.

19. The system of claim 11, wherein the operations further comprise:
determining usage data of the call stack; and
displaying a graphical representation of the usage data in association with the alias assigned to the call stack.

20. The system of claim 11, wherein the operations further comprise appending a fingerprint or a checksum value to the alias assigned to the call stack.
